(19) United States
(12) Patent Application Publication
(10) Pub. No.: US 2003/0033208 A1
(43) Pub. Date: Feb. 13, 2003

(54) Method and system for communicating using a user defined alias representing confidential data

(75) Inventors: Jordi Marin, Barcelona (ES); Linsley Adrian Green, Bedford (GB)

Correspondence Address: CRAIG A. SUMMERFIELD, Brinks Hofer Gilson & Lione, NBC Tower, Suite 3600, P.O. Box 10395, Chicago, IL, 60610, US

(73) Assignee: Alticor Inc.

(21) Appl. No.: 09/928,101

(22) Filed: Aug. 9, 2001

(51) Int. Cl. G06F 17/60

(52) U.S. Cl. 705/26; 705/39

(57) ABSTRACT

A method and system for utilizing a user defined alias for transactions occurring over the Internet. In lieu of repeatedly sending of credit card data or partial credit card identification, a user defined alias is transmitted. By utilizing a user defined alias, the method and system enhances security and convenience.

### BACKGROUND

The Internet has become an enormous resource for consumers. E-commerce allows consumers to seek out products or services using the worldwide searching capabilities of the Internet. Greater accessibility to merchants has enabled consumers to purchase the products they desire for lower prices.

With e-commerce, a consumer purchases products or services from a merchant using computers. The consumer has a computer connected with the Internet using a modem, Ethernet connection, DSL line, or cable modem. Using a web browser, such as Netscape Navigator® or Microsoft Internet Explorer®, the consumer can connect with an e-commerce website. Additionally, a consumer may use a search engine, such as Yahoo®, Excite®, or Lycos®, to find an e-commerce website. Alternatively, several websites provide reviews of products and links to merchant websites.

Since the consumer communicates with the merchant through a computer, the most efficient mode of payment is through the use of a credit card. Credit card payment simply requires entry of data strings. Typically, a series of numbers, such as one series of numbers constituting a credit card number and another corresponding to an expiration date expressed as a month and a year, are provided to or from the merchant. This is more efficient than payment by cash or check because it does not require the transmittal of any tangible item. A cash or check payment requires the physical handling of the document received. A credit card transaction, on the other hand, is not dependent on a piece of paper. Rather, the information needed can be transmitted as a series of bits. Since the server can handle the credit card payment process without human intervention, an e-commerce website operates more efficiently using credit cards.

Additional security measures may be taken to ensure that the use of the credit card is authorized. For example, the consumer may be required to provide his or her home or billing address to the merchant.

Notwithstanding the clear advantages to using credit cards for e-commerce, credit card use raises concerns for the consumer. One concern is that the user's credit card information will somehow be intercepted during transmission from one computer to another. Further, the credit card information may be visible by another person in close proximity with the consumer's computer. Moreover, a hacker may try to steal credit card information from a merchant website. Yet another concern is that the consumer may not have the credit card information for a purchase. For example, a consumer may have given his or her spouse the credit card that accumulates frequent flyer points. The consumer may nonetheless wish to use this card for a purchase, but not have the credit card number.

One attempt at solving these security and convenience concerns is described in U.S. Pat. No. 5,715,399. The '399 patent describes a process that automatically displays on screen the last 5 to 7 numbers of the credit card number used. The consumer enters his or her credit card information and the credit card number is stored in a merchant's database. Thereafter, only a portion of the credit card number is displayed on the computer screen. The method and system of the '399 patent partially address the security and convenience concerns of a consumer, but it does not eliminate them.

First, the method and system described in the '399 patent does not provide complete security because it transfers part of the credit card number. While this is more secure than transferring the entire number over the Internet, it nonetheless could provide a party with partial information that could be used for fraudulent purposes. Second, the method and system described in the '399 patent lacks convenience. If a consumer forgets his or her credit card number or fails to have immediate access to the desired credit card, the consumer may not remember which card is associated with the 5-7 digits. In this case, the method and system in the '399 patent does not adequately provide useful information to the user.

### SUMMARY OF THE PRESENTLY PREFERRED EMBODIMENT

The present invention is defined by the following claims, and nothing in this section should be taken as a limitation on those claims. By way of introduction, the preferred embodiment described below includes a method and system for purchasing goods or services over a computer network using a user defined alias that represents confidential information.

The concerns of security and convenience may be alleviated with the present invention. By allowing a user to select an alias for the confidential information, the present invention empowers the user to create or use a character-based, number-based, or combination of characters and numbers based identifier that makes sense to the user. The alias represents the confidential information, such as a credit card number and its expiration date.

The user is more likely to remember the significance of a character string than a 5-7 digit number generated by a computer. For example, if “Airline Miles” is used as a user defined alias, the user may recognize that this selection will result in payment with the credit card that accumulates points for airline miles. Further, if an unauthorized person gained access to the information transmitted or somehow viewed what was displayed on the screen, that unauthorized person would be unable to decipher the credit card number.

The use of a user defined alias allows the user to control what information represents the confidential information, such as credit card information, stored in a database by another party. Because the alias is created by the user, the credit card system is more secure and convenient. Additionally, with an alias-based system, the valuable confidential information may be stored in a highly secured environment, while the valueless alias is stored in a normal environment.

In order to maintain a secured environment, the system incorporates user and server authentication and transportation level encryption. User authentication is based on an LDAP server. Server authentication and encryption at the transportation level are based use the SSL protocol.

Further aspects and advantages of the invention are discussed below in conjunction with the preferred embodiments.

### BRIEF DESCRIPTION OF THE DRAWINGS

FIG. 1 is a block diagram illustrating one embodiment of an interface between a consumer's computer and a merchant's server.

FIG. 2 is a flowchart depicting an embodiment for receiving confidential data and a user defined alias.

FIG. 3 is a flowchart depicting an embodiment for displaying a user defined alias in lieu of confidential data.

FIG. 4 is a block diagram depicting one embodiment of an Internet based e-commerce environment.

FIG. 5 is a flowchart depicting one embodiment of a registration process utilizing a user defined alias.

FIG. 6 is a screenshot of one embodiment of a registration process utilizing a user defined alias.

FIG. 7 is a flowchart depicting one embodiment of a shopping process utilizing a user defined alias.

FIG. 8 is a screenshot of one embodiment of a shopping process utilizing a user defined alias.

FIG. 9 is a flowchart depicting one embodiment of a profile maintenance process utilizing a user defined alias.

FIG. 10 is a screenshot depicting one embodiment of a profile maintenance process utilizing a user defined alias.

### DETAILED DESCRIPTION OF THE PRESENTLY PREFERRED EMBODIMENTS

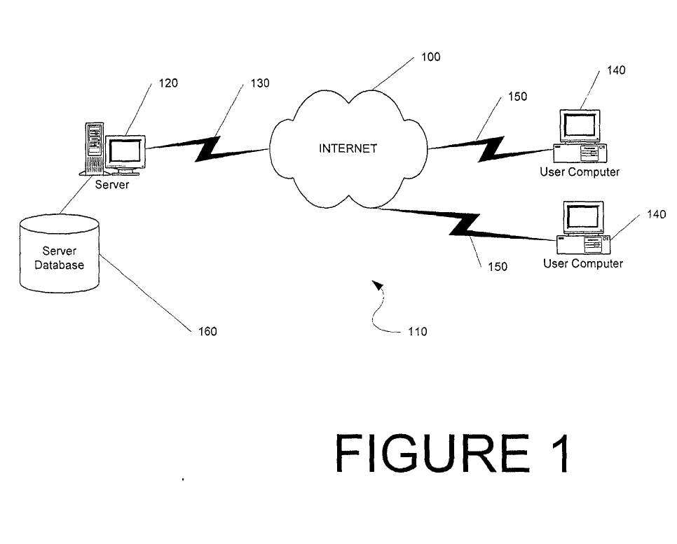

FIG. 1 is a schematic block diagram of a computer network 110 that implements an embodiment of the present invention. The network comprises a plurality of computers 120, 140 that communicate with each other through a wide-area network, which in this embodiment may be the Internet 100. The network 110 preferably includes a server 120. The server 120 is connected to the Internet 110 through communications channel 130. Each user computer 140 is also connected to the Internet through a communications channel 150. In alternative embodiments, the computers 120, 140 may be connected by any network that enables communication between two systems.

The computer network 110 allows a user through a user computer 140 to purchase goods or services from a merchant associated with the server 120. The information necessary to conduct such a transaction is stored in the server database 160. Typically, the user interfaces with the user computer 140 using a web browser, such as Netscape Navigator® or Microsoft Internet Explorer®.

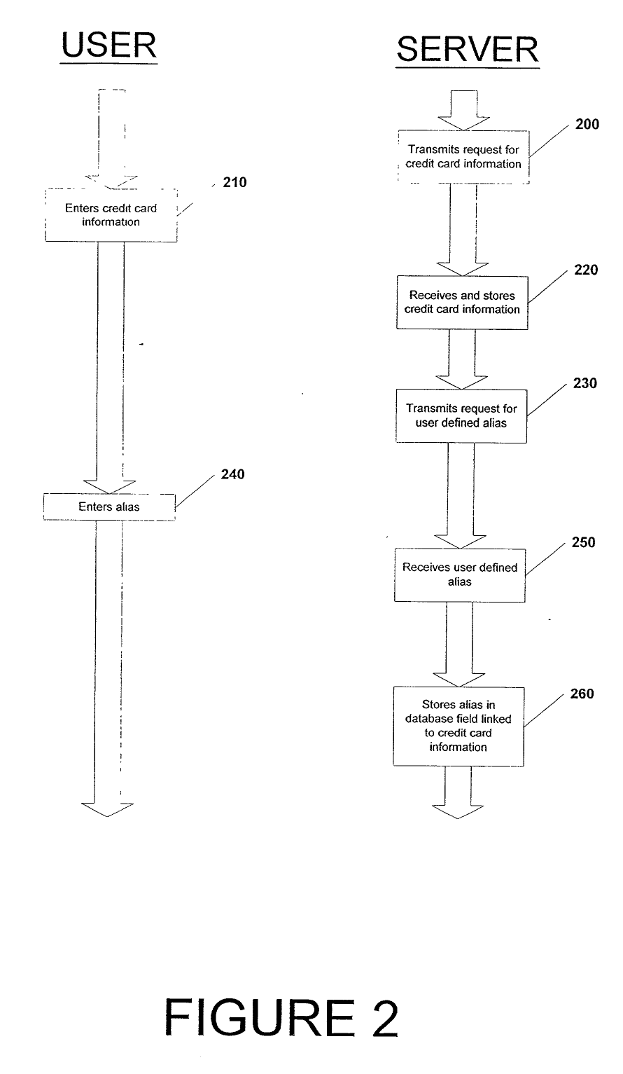

FIG. 2 shows a flowchart of an embodiment for receiving confidential data and a user defined alias. In act 200, the server computer transmits data for a web page requesting the users credit card information. Typically, the requested information includes the type of credit card (VISA, American Express, Mastercard, etc.), the credit card number, and the expiration date (month and year). Additionally, the server may request the billing address or other information for the credit card. Alternatively, a debit card may be used instead of a credit card. In yet other embodiments, a sub-set of the above-listed information is requested.

In act 210, the user enters his or her requested information and sends the information to the server. In act 220, the server receives the requested information and stores the information in a database. Next, in act 230, the server transmits data requesting a user defined alias associated with the requested information. In the alternative, the act 230 may be combined with act 200.

In act 240, the user enters the user defined alias and transmits the alias to the server. In the alternative, act 240 may be combined with act 210. In act 250, the server receives the user defined alias. Next, the server stores the alias in the database in act 260. This alias is linked to the confidential data. Alternatively, act 260 may be combined with act 220. In yet other alternative embodiments, the server assigns an alias. Further, a user may provide credit card information and a user-defined alias through a customer service representative via telephone, facsimile, letter, etc. In this instance, once the credit card and user-defined alias are stored at the server by the merchant, the user-defined alias may be solely utilized for all future transactions.

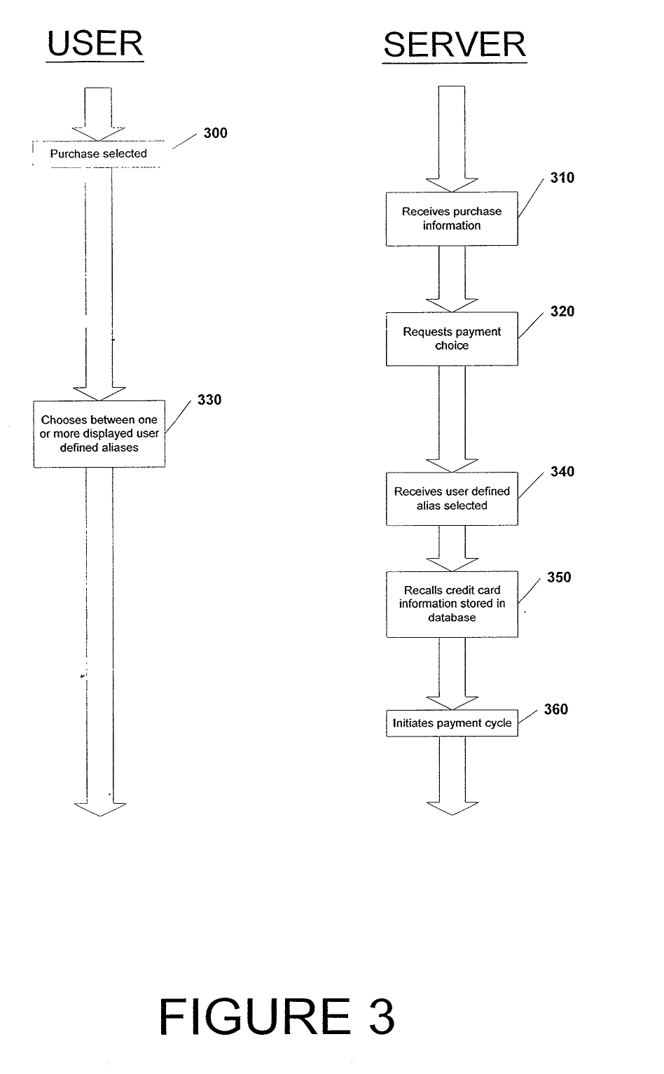

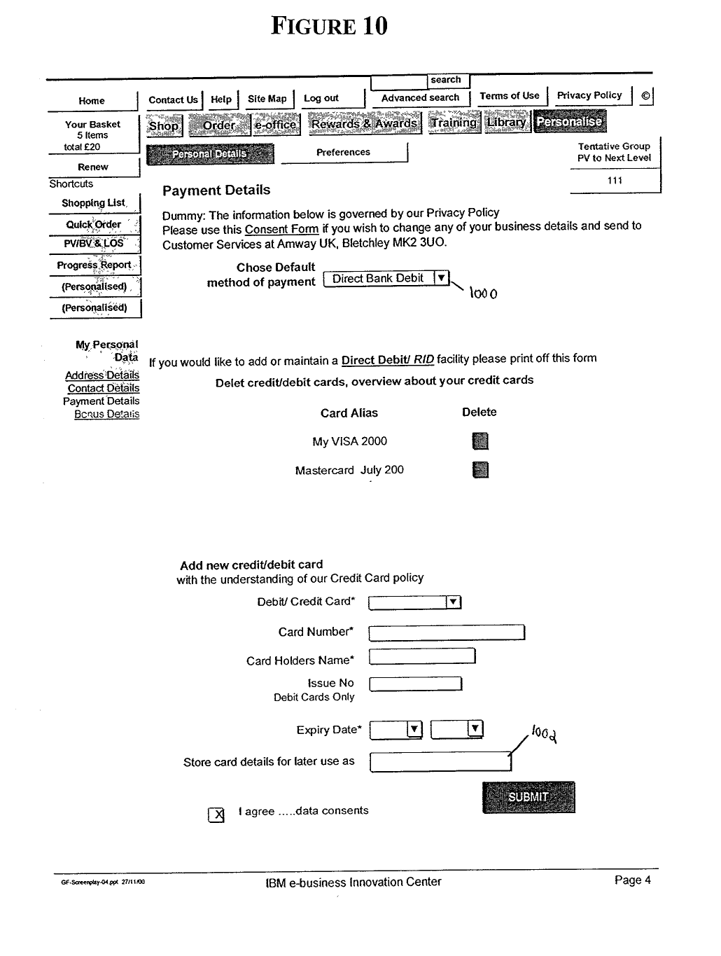

FIG. 3 shows a flowchart of an embodiment for displaying the user defined alias in lieu of the confidential data. In act 300, a user has completed a purchase selection. In act 310, the server receives the purchase information. The purchase information may be associated with one data transfer or multiple data transfers. In act 320, the server sends data to the user's computer requesting a payment choice. The user receives this data in the form of a web page, e-mail or other data format in act 330. FIG. 10 shows a web page of one embodiment. The web page indicates a choice between one or more displayed aliases. Alternatively, or additionally, the page may provide the user with the option to add a new payment method. In act 330, the user selects one of the aliases.

In act 340, the server receives the alias selection. Next, the server uses the alias to look up the credit card information stored in the database in act 350. After the credit card information is obtained, the server initiates a payment cycle in act 360. Additional information, such as asking for the shipping address, may also be requested and transmitted or obtained from the database.

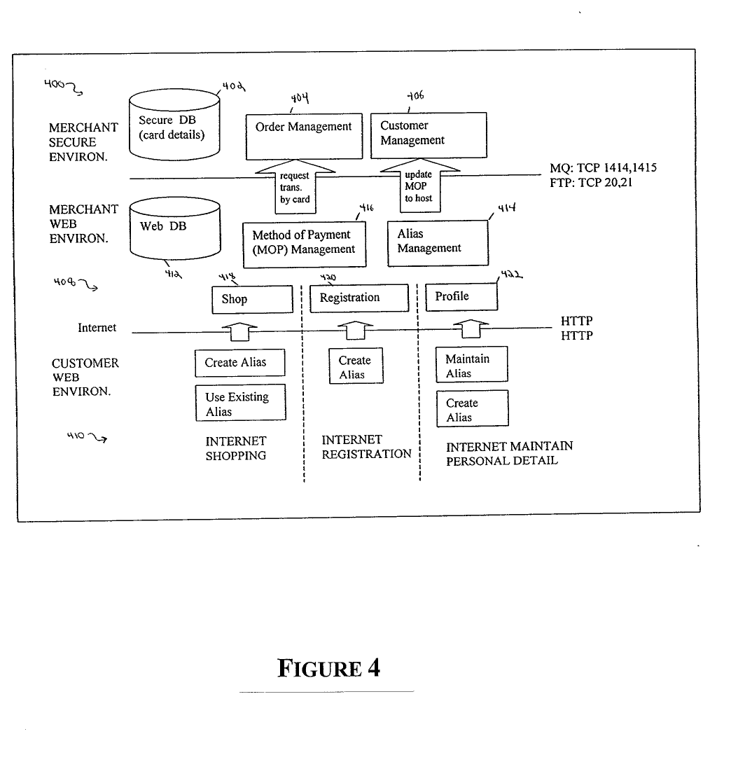

FIG. 4 shows a block diagram of an embodiment of a web based e-commerce environment. Three environments interact during a purchase: the merchant secure environment; the merchant web environment; and the customer web environment.

The merchant secure environment 400 comprises a secure database 402, an order management system 404, and a customer management system 406. The merchant secure environment 400 holds the confidential information. In particular, the secure database 402 contains the credit card details and associated aliases of the customers. By maintaining a separate merchant secure environment 400, the customer is provided with additional protection against credit card fraud.

The second environment is the merchant web environment 408. The merchant web environment interacts with both the merchant secure environment 400 and the customer web environment 410. The merchant web environment 408 stores information used to interact with a customer in a web database 412. The information in these tables can be classified into three categories:

1) Information about the website pages and templates. E.g. data regarding the shopping web page layout.

2) Content of the website. E.g. descriptions, prices, or pictures of available products.

3) Business data. E.g. sales commission data for an individual, orders placed, prices of products, availability of products, or aliases per customer

The merchant web environment controls alias management 414 and method of payment (MOP) management 416. Alias management 414 uses the user defined alias to create or update the method of payment (MOP) detail to customer management 406 and to store the alias on the web database 412. By using the alias in the web environment 408 in lieu of the confidential data in the secure environment 400, the customer is better protected against fraud. Method of payment (MOP) management 416 links with order management 404 to ensure that the proper credit card transaction occurs. Aliases can be read from the web database 412 and displayed on the screen for selection. When the customer selects or uses an alias, method of payment management 416 requests a card transaction in order management 404. Order management 404 substitutes the alias with the credit card number and uses the credit card number for the transaction.

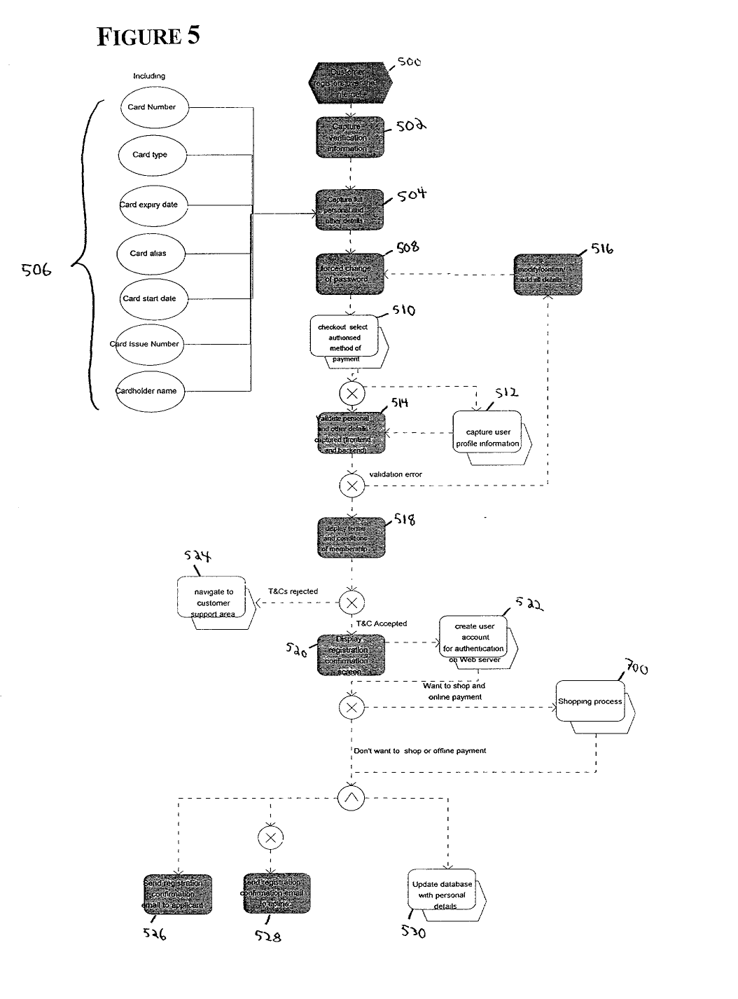

The customer web environment 410 interacts directly with the merchant web environment 408. As controlled by the merchant web environment 408, there are three facets of the customer web environment 410: Shopping 418, Registration 420, and Profile Maintenance 422. These three facets are further described in accordance with FIGS. 5 through 10. In all three facets, the user has the ability to create a new alias or edit existing aliases. While shopping, the user also has the ability to use an existing alias.

FIG. 5 is a flowchart of the registration process. In the embodiment shown in FIGS. 5-10, the registration process is used for a multi-level marketing web site. In alternative embodiments, a sub-set or different acts are provided for registering with and purchasing products or services from other e-commerce retailers. The registration process is initiated in act 500.

The system first captures verification information in act 502. In certain jurisdictions, a user must first submit a signed registration form before using the web site. In these jurisdictions, the user is supplied with verification information in the form of a customer number and a password. This verification information may also take the form of a user name and a password. Where permissible, the act of capturing verification information may be omitted.

Next, in act 504, the system captures information about the user, including credit card information 506. The credit card information 506 includes a card number, card type, card start date (“VALID FROM” date), card expiration date, card alias, a card issue number (for debit cards), and a card holder name. For security reasons, the user is then required to enter a new password in act 508. The user next selects a method of payment in act 510.

After this information has been submitted by the user, the system, in act 512, attempts to validate the information supplied. If the validation results in an error, the system requests that the user modify, confirm, or add details in act 514 and returns the user to act 508. If the validation is successful, the system displays the terms and conditions of membership in act 516. If the user accepts the terms and conditions of membership or purchasing using the alias in act 516, the system displays a registration confirmation screen in act 518 and creates a user account for authentication on the web server 412 in act 520. If the user does not accept the terms and conditions of membership in act 516, the user is directed to a customer support area in act 522.

After a user account is successfully created in act 520, the system asks the user if he or should would like to shop and make an online payment.

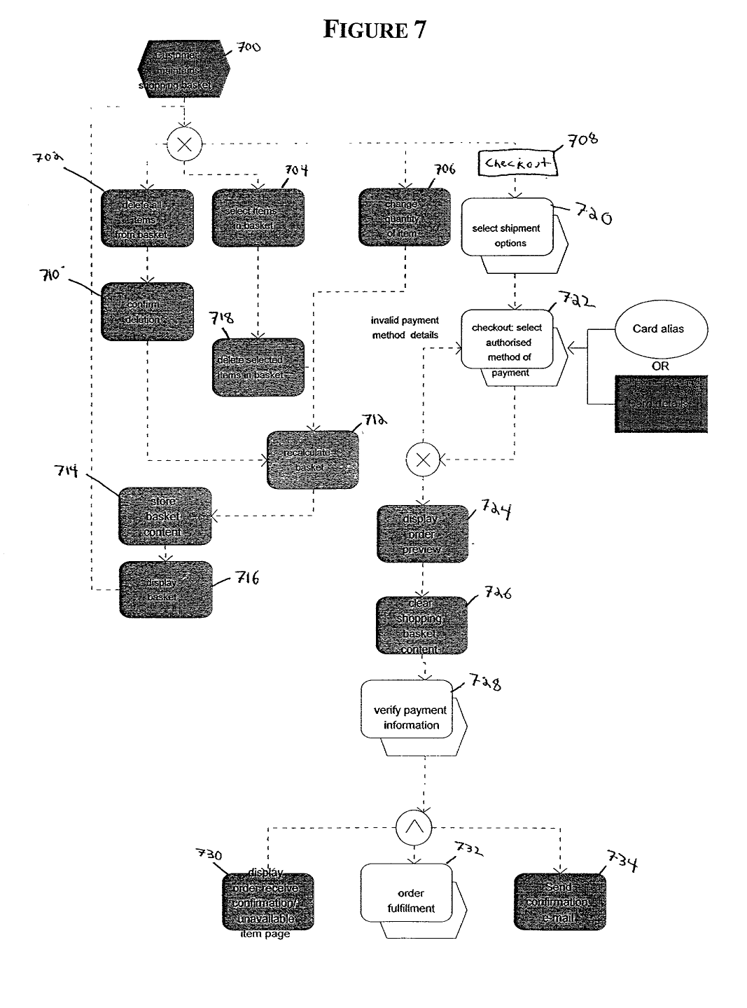

If the user wants to shop and make an online payment, the shopping process is initiated and the system proceeds to act 700, as shown in FIG. 7. If the user does not want to shop or would like to make an offline payment, the system sends a registration confirmation to the user in act 524, sends a registration confirmation email to a sponsor or other member that receives a commission or payment for purchases by the member in act 526, and updates the system database with the personal information submitted in act 528.

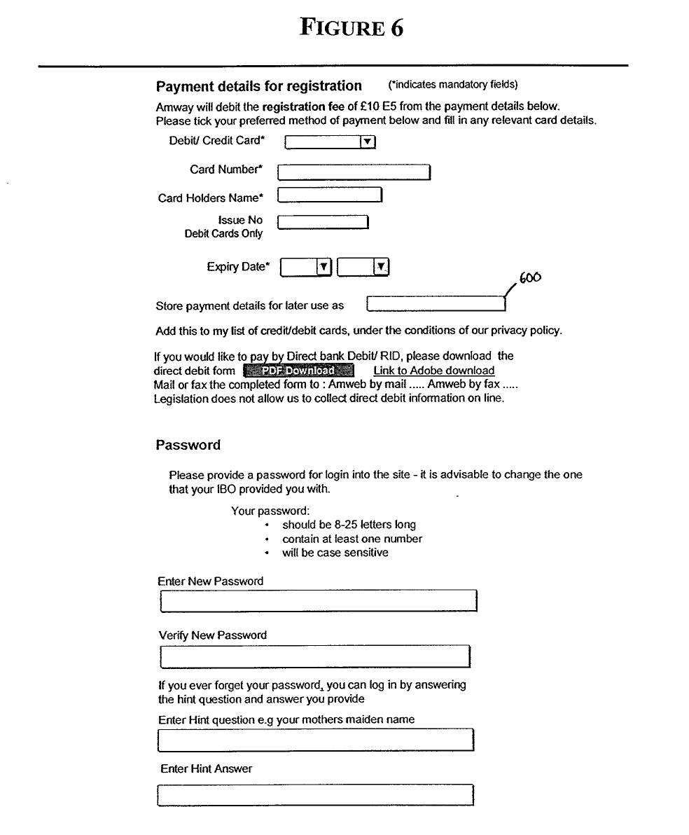

As shown in FIG. 6, a user registration screen allows the user to store their payment details with an alias. After the user has entered his or her payment details for registration, the user has the option of entering an alias in box 600.

FIG. 7 is a flowchart of a shopping process. Act 700 initiates the shopping process. A shopping basket shows the items that the customer has selected to buy. At any given time during the shopping process, the customer has the ability to delete all the items in the basket (act 702), select items in the basket (act 704), change the quantity of the item (act 706), or purchase the items in the basket (act 708). If the user decides that he or she wants to delete all the items in the basket (act 702), the system process to ask for confirmation of the deletion in act 710. If the deletion is confirmed, the system recalculates the basket in act 712. In this case, there are no items in the basket. Next, the system stores the basket content in act 714, displays that content in act 716, and returns to the initiation act 700.

If the user chooses to select one or more items in the basket in act 704, the user may delete the selected items in act 718. If the user chooses to delete one or more items from the basket, the system proceeds to act 712 where it recalculates the basket. Next, the new basket content is recalculated (act 712), stored (act 714), and displayed (act 716). Finally, the system returns to the initiation act 700.

If the user chooses to change the quantity of an item in act 706, the system proceeds to act 712 to recalculate the basket and continues with acts 714 and 716 until the system is in the initialization act 700.

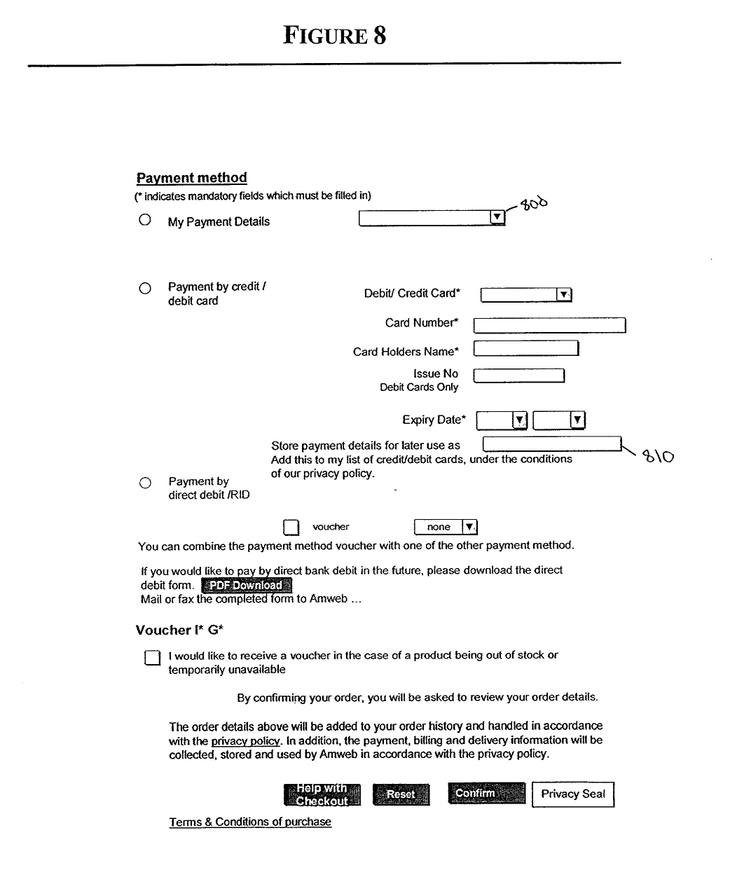

If the user chooses to checkout in act 708, he or she is given a choice of shipment options in act 720. After selecting shipment options, the user chooses a method of payment in act 722. As shown in FIG. 8, the user may enter an alias in field 800, choose from a list of aliases by selecting from the combo field 800, or may enter details for a new credit or debit card and enter a new alias in box 810. A list of aliases may be displayed without requiring selection of the list in the field 800 in other embodiments. Other payment options may also be provided.

If the system verifies the payment method, it proceeds to act 724 where the order may be previewed. If the payment method is invalid, the system returns to act 722.

After the order is displayed, the shopping basket content is cleared in act 726. Next, the payment information is verified in act 728. Finally, the system displays a confirmation that the order was received or displays a notice if the product is unavailable in act 730. The order is fulfilled or further processed for shipment in act 732. A confirmation email may also be sent in act 734.

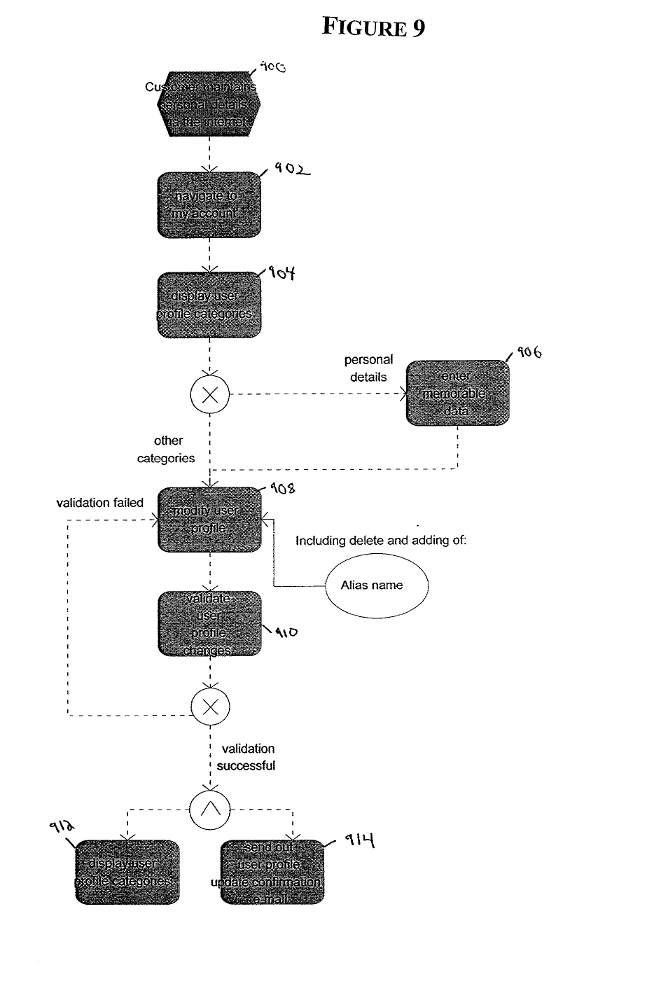

FIG. 9 is a flowchart of the profile maintenance process. The process is initiated in act 900. First, in act 902, the user selects the profile maintenance section of the site by selecting “my account”. In response to this, the system displays the user profile categories in act 904. To view or change personal details the customer is required to enter a password or valid memorable data (e.g. answer hint question) in act 906 before modifying personal details 908. For modifying user profile details not requiring security, the user goes directly to modification of his user profile in act 908. Act 908 also includes modifying, deleting, or adding an alias name. Next, the system validates the user profile changes in act 910. If the validation is successful, the system displays the user profile categories in act 912. Then, the system sends out a user profile update confirmation email in act 914.

FIG. 10 shows profile information, including a list of aliases 1000. An item in this list 1000 may be selected and deleted. This list may also contain an option for Cash on Delivery (COD) payment or direct debiting from a user bank account. A user may also enter new credit or debit card information and provide a new alias in box 1002.

The method and system claimed may also be utilized other information that a user may wish to keep confidential. A user may be requested to display a social security number, an unlisted telephone number, or his or her mother's maiden name. If the user does not want to have to repeatedly enter this information, thereby making it available for on-screen viewing or tampering at another computer location, a user defined alias may be used.

It is to be understood that a wide range of changes and modifications to the embodiments described above will be apparent to those skilled in the art and are contemplated. It is, therefore, intended that the foregoing detailed description be regarded as illustrative rather than limiting, and that it be understood that it is the following claims, including all equivalents, that are intended to define the spirit and scope of the invention.

What is claimed is:

1. A method allowing a user to utilize a user defined alias representing confidential data in communication with a computer server over a network for purchasing products or services, the method comprising:
(a) providing a user defined alias associated with said confidential data;
(b) transmitting said user defined alias from said user to said server;
(c) linking said confidential data with said user defined alias.

2. The method in claim 1 wherein said confidential data comprises a credit card number.

3. The method in claim 2 further comprising the acts of providing an expiration date and receiving said expiration date.

4. The method of claim 3 wherein said expiration date comprises a month value and a year value.

5. The method in claim 1 further comprising performing said act of providing said user defined alias when registering with said computer server.

6. The method in claim 1 further comprising performing said act of providing said user defined alias when said user chooses to make a purchase.

7. The method in claim 1 further comprising performing said act of providing said user defined alias when said user chooses to review the user's registration profile.

8. The method in claim 1 wherein said user and said computer server interact using a web site interface.

9. The method in claim 1 further comprising the act of displaying said user defined alias to said user in lieu of said confidential data.

10. The method in claim 1 further comprising the act of displaying a plurality of user defined aliases to said user.

11. The method in claim 1 further comprising the act of selecting a user defined alias to indicate which one of a plurality of confidential data strings should be used by the server.

12. The method in claim 1 wherein said confidential data string comprises an unlisted telephone number.

13. The method in claim 1 wherein said confidential data string comprises a social security number.

14. A system for utilizing a user defined alias representing confidential data in communication with a computer server over a network, the system comprising:
a server computer having a database operative to store said confidential data string and said user defined alias;
a user computer operative to transmit said user defined alias to said server computer through a network connection; and
a wide-area network communications implementation that connects said user computer with said server computer.

15. The system in claim 14 wherein said wide-area network communications implementation comprises the Internet.

16. The system in claim 14 wherein said confidential data is a credit card number.

17. The system in claim 16 further comprising a server hosting page associated with a product for sale.

18. The system in claim 14 wherein said confidential data is a debit card number.

19. The system in claim 14 wherein said confidential data is a social security number.

20. The system in claim 14 wherein said confidential data is an unlisted telephone number.

21. The system in claim 14 wherein said server computer generates a set of data that is viewable as a web page on said user computer.

22. A system for allowing a user to utilize a user defined alias representing confidential data in communication with a computer server over a network, the system comprising:
a user computer;
a server computer;
a wide-area network communications implementation connected with said user computer and said server computer;
a web browser program operating on said user computer operative to display a customer web environment from data transmitted by said server computer and to receive a user defined alias for credit card information;
a merchant web environment operative to transmit data to said user and receive data entered by said user; and
a merchant secure environment operative to receive data from said merchant web environment and to store confidential data supplied by the user.

23. A method for purchasing on a computer network with a credit card, the method comprising:
(a) providing an alias to a customer in response to a purchase request, the alias being associated with credit card information;
(b) receiving an alias payment request through the computer network in response to (a); and
(c) obtaining the credit card information from a database as a function of the alias.

24. The method in claim 23 further comprising charging a credit for a purchase.

25. The method in claim 23 further comprising providing a list of different aliases.

26. The method in claim 23 further comprising receiving a user login and password.

27. The method of claim 26 further comprising identifying one or more user aliases.
